(19) United States
(12) Patent Application Publication
(10) Pub. No.: US 2015/0259230 A1
(43) Pub. Date: Sep. 17, 2015

(54) SYSTEM AND METHOD FOR CHEMICAL DOSAGE OPTIMIZATION IN WATER TREATMENT AND SYSTEM AND METHOD FOR WATER TREATMENT

(71) Applicant: ECOLAB USA INC., St. Paul, MN (US)

(72) Inventors: Heng Li, Shanghai (CN); Guo Chen, Shanghai (CN); Jian Xu, Shanghai (CN); Chunbo Yu, Shanghai (CN); Liang Cheng, Shanghai (CN); Rodney H. Banks, Loda, IL (US)

(21) Appl. No.: 14/431,022

(22) PCT Filed: Sep. 24, 2013
(86) PCT No.: PCT/US2013/061362

§ 371 Date: Mar. 25, 2015

(30) Foreign Application Priority Data
Sep. 29, 2012 (CN) 2012103803559

(51) Int. Cl. C02F 1/52

(52) U.S. Cl. CPC C02F 1/5209

(57) ABSTRACT

The present invention relates to a system for optimization of dosing in water treatment, a water treatment system and a method therefor. The system for optimization of dosing in water treatment according to the present invention comprises: a chemical reagent addition device, for adding a certain dosage of a chemical reagent into a water sample to be treated at a predetermined interval; an optical detection module, for detecting in real time a change in particle size of particles in the water sample after the addition of the chemical reagent; and a chemical reagent dosage determination device, which determines an optimized dosage of the chemical reagent for coagulating the particles in the water sample, according to the correlation between the change in particle size obtained by the optical detection module and the dosage of the added chemical reagent.

### FIELD OF THE INVENTION

The present invention relates to a system and method for optimization of dosing in water treatment, and system and method for water treatment, which are capable of performing real-time optimization of dosing during the process of water treatment.

### BACKGROUND OF THE INVENTION

A typical wastewater treatment process usually comprises of a primary treatment and a secondary treatment. The stage of the primary treatment mainly includes a process of solid-liquid separation, as natural sedimentation requires a relatively long time, chemical reagents are often added to the water stream so as to precipitate the suspended solids, thereby accelerating the process of sedimentation. The chemical reagents added, known as coagulating reagent, coagulant or flocculant, act on the suspended solids, on the basis of specific physical chemical actions. Stirring and mixing are required for both coagulation and flocculation, so that the particles collide with each other and bind together (coagulate) and then form and grow into flocculates. The mixing for coagulation is vigorous so as to generate a great number of collisions which change the surface properties of the particles, thereby allowing coagulation; while the mixing for flocculation is gentle, the intensity of which is sufficiently high for the collisions to occur but not too high as to break large flocculates.

The selection of the types and dosages of coagulants and flocculants depends on many factors, including the characteristics of these chemical reagents themselves, the concentration, surface characteristics and type of suspended colloids in the water stream, the concentrations and characteristics of natural organic and other organic substances already present in the water stream, the temperature, pH value of the water, and other water quality parameters. At present, the mutual relations among these parameters are only understood qualitatively and the optimized dosages are determined by manual experiments. The prediction of an optimal coagulant composition according to the properties of colloids and water quality cannot be achieved yet. In contrast, the selection of coagulants and flocculants is usually determined by jar tests using various chemical additives.

The jar test, also known as suspended solids separation test, is a laboratory procedure that uses different chemical reagents, mixing speeds and precipitation times to simulate coagulation/flocculation units in water treatment plants or wastewater treatment plants, in which coagulants and flocculants in various dosages are added into a row of beakers so as to estimate the lowest or optimized dosage of a coagulant or flocculant for treating water with a specific quality. The jar test is a standard operation for separating suspended solids in the field of water treatment, in which a series of reference values are used for setting parameters such as stirring intensity, stirring time, operation steps and precipitation time. Due to the method of sampling and testing, the jar test has many disadvantages. Firstly, it cannot quickly respond to the changes in mass/quantity of the wastewater stream, and thus the optimized dosages of the coagulant and flocculant obtained are relatively lagged in time; secondly, a large amount of human labor is needed, which consumes human power and time, responds slowly, and has a relatively high requirement on the operators.

Those skilled in the art have correspondingly been doing research and development on the conventional jar test, attempting to advance the automation technology of the jar test. Some of the prior arts concerning the automation of the jar test will be described below.

The website under the name of the company Accustech (http://www.accustech.com/jartester.html) describes an experimental system for a suspended solids separation test. According to the description provided by this website, the researchers attempted to establish a prototype automation system using the concept of an automatic suspended solids separation tester or a flocculation optimizer for suspended solids separation test. However, this prototype never reached the stage of commercialization, since the project was abandoned on 2006 due to the limit of funds and no further development project has been proposed thereafter. This solution uses a particle counter to measure the efficiency of precipitation.

Korean patent KR 2010000738 discloses an automatic suspended solids separation tester, comprising of a housing, a chemical reagents storage tank, several sample tanks equipped with stirrers, wherein sample tanks are connected to outer pipes used for receiving samples, and several turbidimeters connected to turbidity tubes equipped with an automatic valve, for response to the sample tanks. This is basically an automatic model of the conventional suspended solids separation tester model; however, a large quantity of impurities may accumulate in the sample tanks during the process of wastewater treatment, and corresponding cleaning work will greatly influence the efficiency and cost of this tester in industrial applications.

Korean patent KR 2009061336 discloses a device and method for an automatic suspended solids separation test, the device comprises of at least three tanks, a pump unit, a stirrer, a turbidity testing unit, a calculation unit and a control unit. The device can feed chemical reagents in different dosages into a number of tanks and compare the turbidities of the supernatants, so as to determine the optimized amounts of the chemical reagents to be fed. This device has the same problem as in the device described above.

Korean patent KR 2003044448 discloses a system for an automatic suspended solids separation test. In this system, a plurality of transparent tanks is arranged at the center of a rotary disc, which rotates under the action of a rotation force from a rotation motor. Blades are arranged in the tanks, so that the blades can rotate under the action of the rotation force from the rotation motor. A camera is placed at a position near the rotary disc, which captures, under illumination, photos of flocculates formed in the tanks. This separation system requires the processing of a huge quantity of captured data and observation on the formation of flocculates by human eyes; moreover, the quality of the photographs is poor when the particles overlap on each other;

hence, there is a certain limit on the quality of water to which this system is applied.

The devices for automatic suspended solids separator tests described in the prior art remain substantially in the mode of conventional suspended solids separation testers, which determine the optimized dosage of chemical reagents by putting water samples in a series of beakers or sample tanks, adding reagents of various types and amounts thereto, leaving the same to settle for a period of time and acquiring the formation conditions of flocculates. On one hand, suspended solids in the water stream keep changing over time, so the results obtained by a jar test is relatively lagged in time; on the other hand, the process of a jar sampling test seriously affects the automation in industry, and the cleaning of the sample tanks is also a problem; therefore, it is essentially still a laboratory procedure.

Although the development of automation technologies concerning water treatment can be dated back to 1960s, including the technologies described above, conventional, manual trial-and-error type of suspended solids separation tests are still a widely applied method for dosing chemical reagents in the field of drinking water, particularly the field of wastewater treatment. The problems of high facility cost, requirements for maintenance, inability of updating the data in real time and unreliability, etc., restrict the application of an automatic system in the market of water treatment and wastewater treatment. Therefore, according to the opinion of the inventors of the present invention, the key point for innovation in the suspended solids separation test consists in the construction of a reliable, fast responding, easy in maintenance, and cost effective system and method so as to timely and feasibly simulate the actual reaction conditions and the coagulation of particles, thereby determining the optimized dosages of the coagulant and flocculant.

### SUMMARY OF THE INVENTION

In order to overcome the above shortcomings in the prior art, the present invention discloses a water treatment system, comprising a system for optimization of dosing in water treatment; and a method for water treatment, comprising a method for optimization of dosing in water treatment, which can detect in real time the formation of flocculates in the water stream to be treated, and adjust at any time the dosage of the added chemical reagent, so as to realize the automation in optimization of dosing of the reagent.

In one aspect, the present invention provides a system for optimization of dosing in water treatment, which is used for optimizing the dosage of a chemical reagent for coagulating particles during the water treatment, said system comprising: a chemical reagent addition device, for adding a certain dosage of a chemical reagent into a water sample to be treated at a predetermined interval; an optical detection module, for detecting in real time a change in particle size of particles in the water sample after the addition of the chemical reagent; and a chemical reagent dosage determination device, which determines an optimized dosage of the chemical reagents for coagulating the particles in the water sample, according to the correlation between the change in particle size obtained by the optical detection module and the dosage of the added chemical reagent.

The optical detection module and the chemical reagent addition device are preferably separated by a predetermined distance, and the optical detection module is arranged downstream of the flow of the water sample with respect to the chemical reagent addition device.

In the system for optimization of dosing in water treatment according to the present invention, said optical detection module comprises: a light-emitting section, for emitting light to the water sample; a light-receiving section, for receiving one or more of the reflected light, transmitted light, and scattered light from the water sample; and an optical signal processing section, for converting the light from the light receiving section into an electrical signal, and determining the change in particle size of the particles in the water sample according to the electrical signal.

In the system for optimization of dosing in water treatment according to the present invention, the chemical reagent addition device can increase the dosage of the chemical reagents successively at the interval, and the increment of the dosage of the chemical reagent is preset.

Preferably, the system for optimization of dosing in water treatment according to the present invention further comprises a data transmitting device, which transmits and records a change value in particle size obtained by the optical detection module, and controls and records the dosages added each time by the chemical reagent addition device.

In the system for optimization of dosing in water treatment according to the present invention, the chemical reagent addition section determines the current dosage of the chemical reagent to be added into the water sample according to the change value in particle size caused by previous addition of the chemical reagent into the water sample. Alternatively, the chemical reagent addition section determines the current dosage of the chemical reagent to be added into the water sample according to the change values in particle size caused by the previous two additions of the chemical reagent into the water sample.

Furthermore, if the change in particle size measured after previous addition of the chemical reagent is smaller than a predetermined threshold, the chemical reagent addition device increases the amount of the reagent to be added; and if the change in particle size measured after the last addition of the chemical reagent is greater than the predetermined threshold, the chemical reagent addition device decreases the amount of the reagent currently to be added or keeps it unchanged. Since a change in the addition amount of the reagent leads to flocculation and coagulation, thus forming a flocculate or a precipitate, the system for optimization of dosing in water treatment according to the present invention continuously adjusts the amount of the reagent added by detecting in real time the change in particle size, and finally determines an optimized dosage for the chemical reagent.

The system for optimization of dosing in water treatment according to the present invention further comprises a water stream adjusting section, which adjusts the stability and residence time of the water stream. In this case, the water stream adjusting section is a pipe system consisting of straight pipes and bent pipes.

The system for optimization of dosing in water treatment according to the present invention further comprises a mixer arranged upstream of the water stream with respect to the optical detection module, for fully mixing the water stream and the added chemical reagent.

By adjusting the mixing intensity and the corresponding hydraulic residence time, blockage of the inventive system for optimization of dosing in water treatment is prevented and the turbidity of the water is reduced.

The system for optimization of dosing in water treatment according to the present invention further comprises one or more of a tap water supply section, a compressed air supply section, and a supersonic transmitter, wherein the tap water supply section and the compressed air supply section can supply tap water and compressed air respectively to the pipes so as to clean the pipes, and the supersonic transmitter can transmit a supersonic wave to an optical probe of the optical detection module, so as to clean the optical probe. In this case, the supersonic transmitter may be arranged at a position near the optical probe of the optical detection module.

The system for optimization of dosing in water treatment according to the present invention further comprises a water quality parameter monitoring section, which monitors a water quality parameter of the water sample to determine whether the water sample is suitable for a particle coagulation process, wherein said water quality parameter includes one or more of the pH value, temperature, pressure and flow. It can further comprise an alerting section, which issues an alarm to a user if the water quality parameter monitoring section determines that the water sample is not suitable for a particle coagulation process. In this case, with respect to the chemical reagent addition section, the water quality parameter monitoring section is preferably arranged upstream of the water stream.

The system for optimization of dosing in water treatment according to the present invention further comprises a pre-treatment section, which pre-treats the water sample to adjust a water quality parameter of the water sample, so that the water sample is suitable for a particle coagulation process, wherein said water quality parameter includes one or more of the pH value, temperature, pressure and flow.

In another aspect, the present invention also provides a water treatment system, which comprises: a main water stream; a bypass water stream, which is a partial water stream or branched water stream extracted from the main water stream; a system for optimization of dosing in water treatment described above in the present invention, which is used for adding a certain dosage of a chemical reagent into the bypass water stream at a predetermined interval, so as to determine an optimized dosage of the chemical reagents for coagulating particles to be added in the bypass water stream; and a main dosing device, which determines the dosage of the chemical reagent to be added into the main water stream according to the optimized dosage of the chemical reagent determined by the system for optimization of dosing in water treatment, and adds the chemical reagent into the main water stream.

In this case, according to the water treatment method of the present invention, said main dosing device determines the dosage of the chemical reagent required to be added in the main water stream by multiplying the dosage in the bypass water stream determined through the system for optimization of dosing in water treatment by a flow ratio between the main water stream and the bypass water stream.

In another aspect, the present invention also provides a method for optimization of dosing in water treatment, which is used for optimizing the dosage of a chemical reagent for coagulating particles, the method comprising the following steps: (a) adding a certain dosage of a chemical reagent into the water sample to be treated at a predetermined interval; (b) detecting in real time a change in particle size of the particles in the water sample after the chemical reagent is added by using an optical signal; and (c) determining an optimized dosage of the chemical reagent for coagulating particles in the water sample, according to the correlation between the change in particle size detected by the optical signals and the dosage of the added chemical reagent.

Herein step (b) further comprises: emitting light towards the water sample; receiving one or more of the reflected light, transmitted light, scattered light from the water sample; and converting the received light into an electrical signal, and determining the change in particle size in the water sample according to the electrical signal.

In step (a), the dosage of the chemical reagent is increased successively at the interval, and the increment of the dosage of the chemical reagent is preset.

In this case, in step (a), the current dosage of the chemical reagents to be added into the water sample is determined according to the change value in particle size caused by the previous addition of the chemical reagent into the water sample. The current dosage of the chemical reagent to be added into the water sample may also be determined according to the change values in particle size caused by the previous two additions of the chemical reagent into the water sample. Moreover, if the previously measured change in particle size is smaller than a predetermined threshold, the chemical reagent addition device increases the amount of the reagent to be added; and if the previously measured change in particle size is greater than the predetermined threshold, the chemical reagent addition device decreases the amount of the reagent currently to be added or keeps it unchanged.

The method for optimization of dosing in water treatment according to the present invention further comprises adjusting the stability and residence time of the water stream.

The method for optimization of dosing in water treatment according to the present invention further comprises fully mixing the water stream and the added chemical reagent, prior to using the optical signal to detect in real time the change in particle size in the water sample after the addition of the chemical reagent.

The method for optimization of dosing in water treatment according to the present invention further comprises supplying tap water and compressed air to the pipes so as to clean the pipes through which the water sample flows, and/or using a supersonic wave to clean a optical probe of an optical signal detecting device.

The method for optimization of dosing in water treatment according to the present invention further comprises monitoring a water quality parameter of the water sample to determine whether the water sample is suitable for a particle coagulation process, wherein said water quality parameter includes one or more of the pH value, temperature, pressure and flow.

The method for optimization of dosing in water treatment according to the present invention further comprises issuing an alarm to a user if the water quality parameter monitoring section determines that the water sample is not suitable for a particle coagulation process.

The method for optimization of dosing in water treatment according to the present invention further comprises pre-treating the water sample to adjust a water quality parameter of the water sample, so that the water sample is suitable for a particle coagulation process, wherein said water quality parameter includes one or more of the pH value, temperature, pressure and flow.

In still another aspect, the present invention provides a water treatment method, which comprises: extracting a bypass water stream or a branched water stream from a main water stream; determining an optimized dosage of the chemical reagent for coagulating particles in the bypass water stream by means of the method for optimization of dosing in water treatment described above in the present invention; determining the dosage of the chemical reagents to be added into the main water stream according to the optimized dosage of the chemical reagent determined by the method for optimization of dosing in water treatment, and adding the chemical reagent into the main water stream.

In the method for optimization of dosing in water treatment according to the present invention, the dosage of the chemical reagents required to be added in the main water stream is determined by multiplying the dosage determined through the system for optimization of dosing in water treatment by a flow ratio between the main water stream and the bypass water stream.

The system and method for optimization of dosing in water treatment and the system and method for water treatment according to the present invention solve the problems in the prior art, which can not only be used as an independent apparatus in laboratory for screening of chemical reagents and determination of optimal dosages, but also can be applied in wastewater treatment in industry.

The system for optimization of dosing in water treatment according to the present invention can replace some of the human labor involved in a conventional jar test, thereby overcoming the shortcomings in manual jar separation tests and accelerating the water treatment process in a more standardized and cost-saving manner.

The system and method according to the present invention measure the change in size of suspended particles in real time by means of an optical detection module, thereby detecting automatically in real time the extent of flocculation and coagulation of the suspended matter in the water sample to be treated, and determine the optimized dosage of the chemical reagent according to the correlation between the information about the change in particle size and the change in the dosage of the chemical reagents, so as to obtain a stable suspension, thereby improving significantly the operation efficiency and treatment effects of the water treatment.

### BRIEF DESCRIPTION OF THE DRAWINGS

FIG. 1 is a schematic view of a system for optimization of dosing in water treatment according to an embodiment of the present invention.

FIG. 2 is a flow chart of a system for optimization of dosing in water treatment according to an embodiment of the present invention.

FIG. 3 is a diagram of the comparison of optimal dosages determined by a system for optimization of dosing in water treatment according to the present invention and by using a jar test.

FIG. 4 is a diagram of the comparison of optimal dosages determined by a system for optimization of dosing in water treatment according to the present invention and by using a jar test.

FIG. 5 is a diagram of the comparison of optimal dosages determined by a system for optimization of dosing in water treatment according to the present invention and by using a jar test.

### DETAILED DESCRIPTION OF THE INVENTION

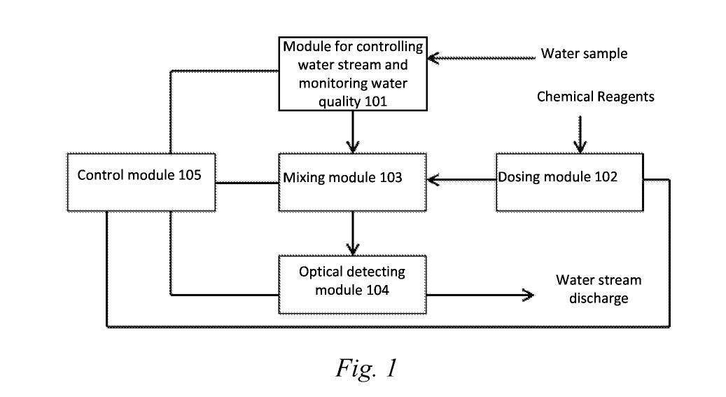

FIG. 1 shows a schematic view of a system for optimization of dosing in water treatment according to an embodiment of the present invention. As shown in FIG. 1, the system for optimization of dosing in water treatment according to the present invention comprises a water flow control and quality monitoring module 101, a dosing module 102, a mixing module 103, an optical detection module 104 and a control module 105.

In this embodiment, a water sample from the main water stream or a bypass water stream is firstly drawn in and flows through the water flow control and quality monitoring module 101. Subsequently, the dosing module 102 adds a chemical reagent into the water sample. The chemical reagent and the water sample are mixed in the mixing module 103, and the water sample mixed with the chemical reagent is detected by the optical detection module 104 before discharge. The control module 105 can control the water flow control and quality monitoring module 101, the dosing module 102, the mixing module 103 and the optical detection module 104. In particular, the control module 105 can determine the optimal dosage of the chemical reagent for coagulating particles in the water sample, according to the correlation between the dosage of the chemical reagent added by the dosing module 102 and a signal detected by the optical detection module 104.

In particular, a flow control section of the water flow control and quality monitoring module 101 can adjust in real time the flow and velocity of the water sample drawn in. The flow control section of the water flow control and quality monitoring module 101 may be embodied by a pipe system consisting of straight pipes and bent pipes. When a water stream flows in the pipe system, as the straight pipes and the bent pipes are combined in a certain sequence, it is possible to ensure the stability of the water stream and a proper hydraulic residence time. Those skilled in the art can understand that various combinations of straight pipes and bent pipes may be readily designed in order to achieve the objects, according to the stability of the water stream and the hydraulic residence time. Moreover, by means of the control of the control module 105, the water stream drawn in by the water flow control and quality monitoring module 101 can keep a predetermined stability in flow. The flow rate may range from 1 cm/s to 100 cm/s, preferably 3 cm/s to 40 cm/s, more preferably 5-30 cm/s. Those skilled in the art can also adjust the diameter of the pipes according to the growth time of the particles flocculated or coagulated from suspended solids, and a slower flow rate may be employed. It should be clear that the range for flow rate given here is only an example, while in practice the flow rate may be controlled at different values or ranges as needed. By the control of the water stream through the module 101, it may be ensured that the water stream is stable during the optical detection, and that the system of the present invention has the ability to treat abrasive fluids containing suspended solids as well as highly turbid liquid, having a wider range of application.

A water quality monitoring section of the water flow control and quality monitoring module 101 can continuously monitor water quality parameters, so as to determine whether the water sample is suitable for a particle coagulation process. The water quality parameters may include the flow, pressure, temperature, and pH value. Moreover, the water quality monitoring section of the water flow control and quality monitoring module 101 can also send the monitored water quality parameters to the control module 105, so as to determine the dosing range for the chemical reagent and the necessary changes in the increasing step at the dosing control module 101. In one embodiment, in order for a water sample to be suitable for a particle coagulation process, the range for flow may be from less than unit liter per minute to 10 liters per minute; a range for pressure may be from atmospheric pressure (or 0 bar) to 2 bars; a range for temperature may be from less than 10 degree Celsius to 80 degree Celsius; and a range for pH of the water may be from 5 to 10. It should be clear that the parameter values given here are merely by way of example, while in practice the parameters may be set at different values or ranges as needed. Those skilled in the art can understand that the water flow control and quality monitoring module 101 is a component for enabling the inventive system to treat water for different environments, but is not an absolutely necessary component for realizing the present invention. For example, if it is beforehand known that the water sample is suitable for a particle coagulation process, the water flow control and quality monitoring module 101 may be omitted, without the need of monitoring the water quality parameters.

Optionally, the water flow control and quality monitoring module 101 may display the detected parameters (including the flow, pressure, temperature and pH value) on a human-machine interface (HMI). Moreover, if the water flow control and quality monitoring module 101 determines that the water sample is not suitable for a particle coagulation process, it can send an alarm signal to a user through the alerting section, thereby prompting the user to take a corresponding action. Moreover, if the water flow control and quality monitoring module 101 determines that the water sample is not suitable for the particle coagulation process, the water flow control and quality monitoring module 101 may also send a signal to the control module 105, so as to activate the pre-treatment section to pre-treat the water sample. The pre-treatment section can pre-treat the water sample to adjust a water quality parameter of the water sample, so as to render the water sample suitable for a particle coagulation process.

The dosing module 102 is used for adding a certain dosage of chemical reagent into a water sample to be treated at a predetermined interval, which comprises a chemical reagent storage section and a chemical reagent dosing pump. A chemical reagent or chemical reagents is/are stored in the chemical reagent storage section. The chemical reagent storage section may be a storage tank. The tanks may be made from various materials, including but not limited to, PVC, glass, stainless steel, PP and Pyrex (borosilicate glass). The volume of the tank may range from 0.5 liter to 10 liters. The shape of the tank may be circular or square or rectangular, or any other regular shape. As the chemical reagent dosing pump, a small-scale chemical reagent dosing pump may be employed, for drawing the chemical reagent out from the storage tank and injecting the chemical reagent into the water stream. Alternatively, those skilled in the art can set the volume, material and shape of the chemical reagent storage tanks according to the practical requirements in production.

In one embodiment, the chemical reagent dosing pump can inject the chemical reagent directly into the mixing module. The time interval between additions of the chemical reagent and the dosage of the chemical reagent added each time, by dosing module 102 into the water sample, may be manually predetermined beforehand, or may be determined dynamically by the control module 105. In one embodiment, the dosing module 102 can adjust the dosage of the chemical reagent in a step-wise manner, ranging from a single step to as many as 50 steps. The step size can be determined statically with specific values of 1 mL/min to 10 mL/min. In one embodiment, the dosing module 102 can determine the dosage of the chemical reagent dynamically with the input from the control module 105. The control of the dosage at the dosing module 102 will be described below in detail.

The mixing module 103 can mix the chemical reagent added by the dosing module 102 with the water sample. In the mixing module 103, advantageous hydraulic conditions are generated, so as to mix said chemical reagents and said water sample well. The mixing module 103 may be a static mixer in any form. Preferably, the friction head loss of the static mixer is not greater than 0.5 bar. Once the chemical reagent and the water sample are well mixed by the mixing module 103, the mixed flow discharged by the mixing module 103 may be directed to a flow section without turbulence (Reynolds number greater than 10,000), thereby providing a gentle water flow downstream of the mixing module 103. During the gentle flow time, the suspended particles in the water sample aggregate with each other to form larger particles under the action of the chemical reagent. The extent of particle aggregation varies depending on the types and dosages of the added chemical additives, which has a dominant influence on the settling properties of the aggregated particles.

The optical detection module 104 can detect in real time the changes in particle size of the particles in the water sample after the addition of the chemical reagents. The optical detection module 104 is arranged downstream of the dosing module 102, and they are separated by a predetermined distance. In this case, the distance between the optical detection module 104 and the dosing module 102 is provided such that the added chemical reagent and the water sample to be treated are fully mixed and the water stream become relatively gentle before it reaches the optical detection module 104. In industrial applications, those skilled in the art can determine a rational distance between the optical detection module 104 and the dosing module 102, according to the flow of the main water stream or the bypass water stream, the dosage of the chemical reagent and the action intensity of the mixing module.

Preferably, the optical detection module 104 is arranged at the flow section downstream of the mixing module 103, where no turbulence is present, for detecting the water sample. In one embodiment, the optical detection module 104 can detect the change in particle coagulation after the addition of the chemical reagent, compared with a reference condition where no chemical reagent is added. Optionally, the optical detection module can record the detected change in particle coagulation, and reports it as “flocculation index or FI”. The optical information (FI) is well correlated to the settling properties of the aggregated particle, which is known to those skilled in the art.

In one embodiment, the optical detection module 104 can include a light emitting section for emitting light to the water sample, a light receiving section for receiving one or more of the reflected light, transmitted light and scattered light from the water sample, and an optical signal processing section. The optical signal processing section converts the light received from the light receiving section into an electrical signal, and determines the change in particle size of the particles in the water sample according to the electrical signal. It should be noted that the structure of the optical detection module 104 described here is merely an example, while any sensor that can detect the change in particle size may be used as the optical detection module 104 in the present application, irrespective of what sensing principle it adopts or whether it is capable of imaging.

The control module 105 can determine the optimal dosage of the chemical reagent for coagulating particles in the water sample, according to the correlation between the dosage of the chemical reagent added by the dosing module 102 and the optical signals detected by the optical detection module 104. Preferably, the correlation between the dosages of the added chemical reagents and the optical signals may be displayed graphically on the human-machine interface. Moreover, the control module 105 can also determine the current dosages of the chemical reagents required to be added into the water sample according to the correlation between the dosage of the added chemical reagent and the optical signals.

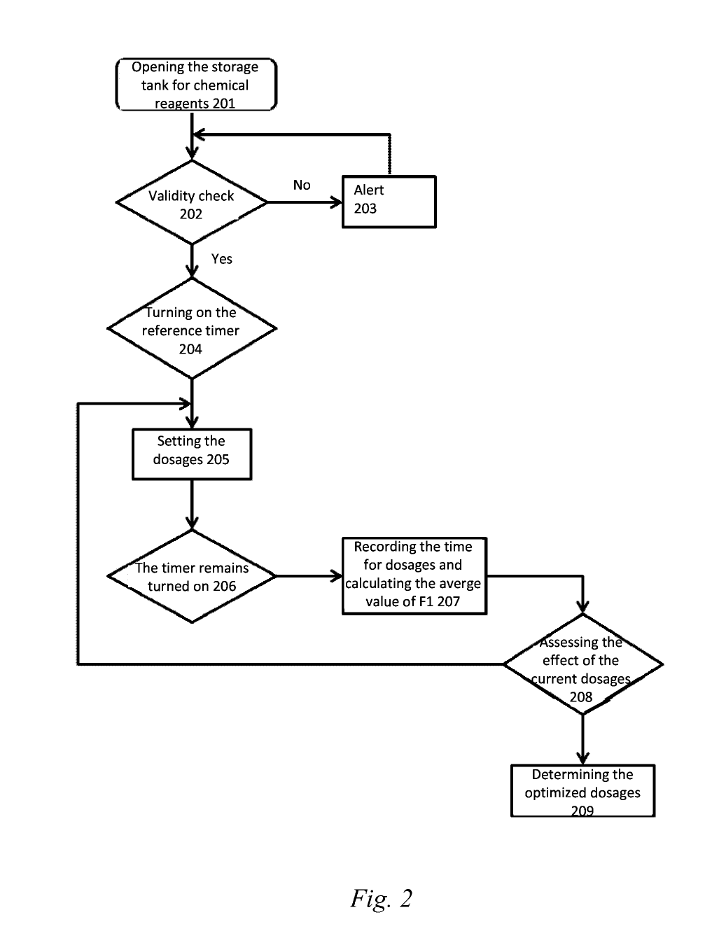

FIG. 2 shows a flow chart of an embodiment according to the present invention for controlling and determining the optimized dosage of the chemical reagent. Chemical reagent storage tanks are opened at step 201 to prepare for the addition of the chemical reagents, and then a validity check is performed at step 202 to make sure that a sufficient amount or a predetermined amount of the chemical reagents is added. For example, if a value obtained from the validity check is not within a range of set values, e.g. 50 mL to 500 mL, an alarm signal is displayed on the HMI. It is also possible to send the alarm signal further to an operator. If the value from the validity check meets a set value, step 204 will be started.

Before adding any chemical reagent, the “reference timer” is turned on to collect a reference optical signal or reference “flocculation index (FI)” of the water sample to be treated, to which no reagent is added, i.e. the step 204 in FIG. 2. After successful acquisition of the reference FI value, an initial dosage is set at step 205, which usually depends on the quality of the water sample. Generally, for the initial dosage, reference can be made to the average dosage, that is, a dosage generally required in water treatment. If no average dosage is available for reference, the dosage may be set randomly. Subsequently, the chemical reagent is added into the water sample according to the dosage determined.

At step 206, a retentive timer is turned on, so that the dosing rate is kept constant for a period of time, for example the same dosing rate is kept for 30 s to 300 s. At step 207, the dosing duration is recorded, and a continuous optical detection is performed and the optical signals are computed, thereby obtaining an average FI value. At step 208, the average FI value obtained at the current dosage is compared with the reference FI value without dosing obtained at step 204, so as to assess the effect of flocculation after the addition of the current dosage. Depending on the assessment result of the comparison between the current FI value and the reference FI value, the procedure can return to step 205 for resetting a new dosage, and the current assessment result can also direct the corresponding adjustment of the next dosage of chemical reagent and setting of a new dosing rate; then steps 206 and 207 are repeated, the FI value obtained at step 207 is compared with the average FI value of the previous additions, and the effect of flocculation after changing the dosage is again assessed. The loop is repeated until a good assessment result is shown, so that the optimized or optimal dosage of the added chemical reagent is determined at step 209.

The control mode for the optimization of dosing shown in FIG. 2 is merely an embodiment of the present invention. The dosing module of the present invention can adopt other different dosing modes. For example, the dosing module 103 may be preset, so that it increases the dosage of the chemical reagent progressively and successively at the interval, and the increment for the chemical reagent is preset. Optionally, the dosing module 103 can dynamically determine the current dosage of the chemical reagent to be added into the water sample according to the change value in particle size caused by previous addition of the chemical reagent into the water sample. In particular, the dosing module 103 can determine the current dosage of the chemical reagent to be added into the water sample according to the change values in particle size caused by the previous two additions of the chemical reagent into the water sample. If a previously measured change in particle size is smaller than a predetermined threshold, the dosing module 103 can increase the amount of the reagent to be added; and if the previously measured change in particle size is greater than the predetermined threshold, the dosing module 103 can decrease the amount of the reagent to be added or keeps it unchanged.

Furthermore, the method for optimization of dosing in water treatment according to the present invention can further comprise a cleaning module for regularly or irregularly cleaning the components in the system that are in contact with the water. For example, the cleaning module can comprise one or more of a tap water supply section, a compressed air supply section, and a supersonic transmitter. The tap water supply section and the compressed air supply section can provide tap water and compressed air to the pipes for cleaning the same. The supersonic transmitter can transmit a supersonic wave towards sensitive parts included in the optical detection system, e.g. an optical probe, so as to clean the optical probe. The supersonic transmitter may be arranged at a position near the optical probe of the optical detection system.

The invention resides in the ingenuity of turning the existing, conventional jar test procedure for suspended solids separation to an automation method and apparatus that draw in a water sample in a continuous manner, instead of the batch manner in a manual test for suspended solids separation, and quickly measure the particle settling property without actually waiting for the particles to settle. Optimal dosages of chemical reagents that effect the best particle aggregation and settling can be timely determined. This significant improvement results in savings in both labor and time. Furthermore, the standard procedure afforded by the automatic operation of the present invention ensures improved reliability and repeatability of test results across different types of water containing different types of suspended particles.

The above description and explanation may be better understood by referring to the embodiments below, which are intended for illustrative purposes and are not intended to limit the scope of the invention.

### EXAMPLE 1

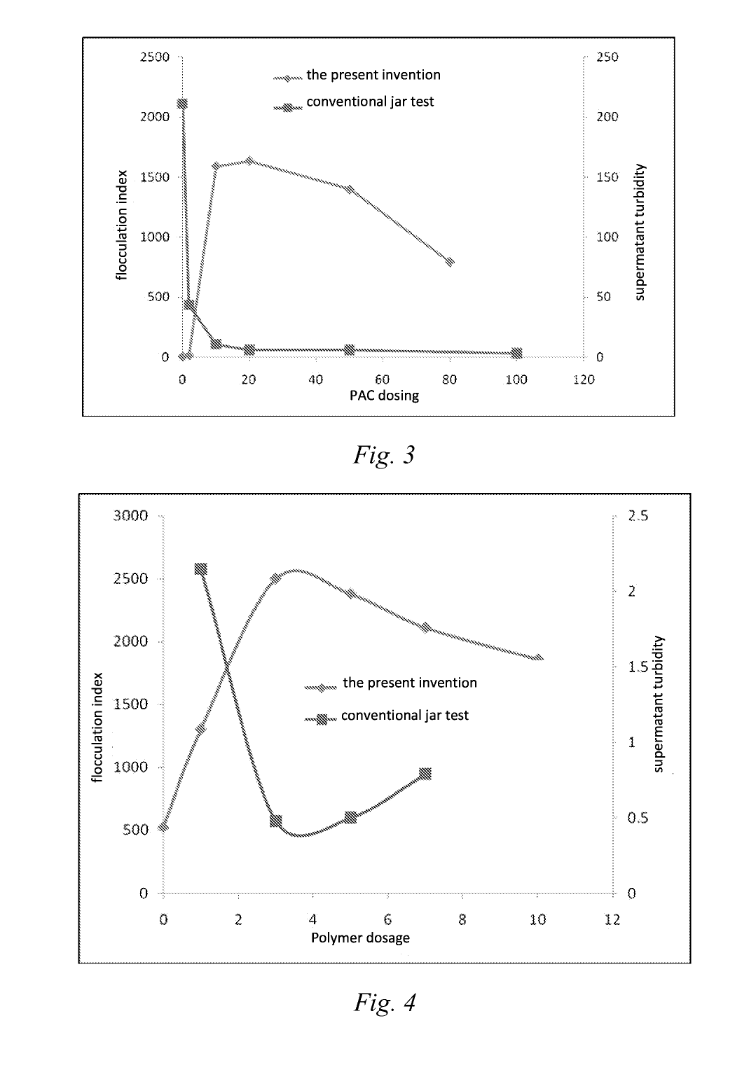

In example 1, a water sample containing inorganic particle materials, Kaolin or similar soil particles is used. Poly aluminium chloride (PAC) as coagulant, and poly acrylamide (PAM) as flocculant are selected to treat the water sample for suspended solids settling. The dosage for the flocculant is 2 ppm, and the dosage for the coagulant ranges from 0 to 100 ppm. For this water sample, a system for optimization of dosing in water treatment according to the present invention and an existing jar test are used respectively to determine the optimal dosages for the chemical reagents required for coagulating particles in the water sample. FIG. 3 shows the chemical performance curve obtained by the system for optimization of dosing in water treatment described in the present invention and the curve obtained by the existing jar test. In FIG. 3, the abscissa represents the PAC dosage, the left ordinate represents the flocculation index, and the right ordinate represents the supernatant turbidity. Curve 301 represents the correlation between the PAC dosage and the flocculation index obtained by the present invention. Curve 302 represents the correlation between the PAC dosage and the supernatant turbidity obtained by the present invention. It is clear from FIG. 3 that there is a good correlation between the results obtained by the system for optimization of dosing in water treatment according to the present invention and those obtain by manual suspended solids separation tests. The optimal dosage obtained at the maximal flocculation index (FI) corresponds to the dosage point determined according to the precipitation turbidity in manual suspended solids separation tests.

### EXAMPLE 2

In example 2, an industrial wastewater sample containing suspended calcium or magnesium particles, taken from a semiconductor manufacturing plant, is used. After it is treated by PAC and the calcium particles are stabilized, the suspension is further treated with a flocculant to improve the coagulation and precipitation of the particles. For this water sample, the system for optimization of dosing in water treatment according to the present invention and a conventional jar test are used respectively to determine the optimal dosage for the chemical reagent required for the coagulation of the particles in the water sample. FIG. 4 shows the chemical performance curve obtained by the method for optimization of dosing in water treatment described in the present invention and the curve obtained by the existing jar test. In FIG. 4, the abscissa represents the polymer dosage, the left ordinate represents the flocculation index, and the right ordinate represents the supernatant turbidity. In FIG. 4, curve 401 represents the correlation between the polymer dosage and the flocculation index obtained by the present invention. Curve 402 represents the correlation between the polymer dosage and the supernatant turbidity obtained by the present invention. The results indicate that the optimal dosage obtained according to the present invention at the maximal flocculation index (FI) is consistent with the optimal dosage determined according to the supernatant turbidity by manual suspended solids separation tests.

### EXAMPLE 3

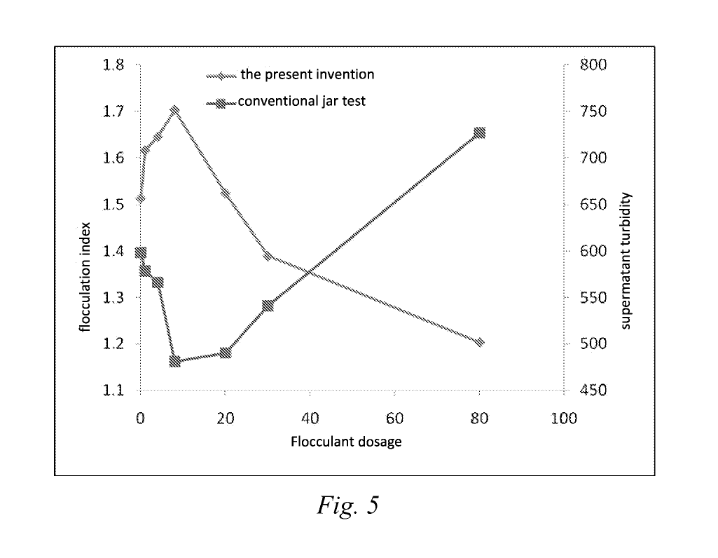

In example 3, a water sample containing organic particles of cellulose fibers and a certain amount of grease is used. The system for optimization of dosing in water treatment according to the present invention and the conventional jar test are used respectively to determine the optimal dosage for the chemical reagent required for the coagulation of the particles in the water sample, and the dosage curves determined by the two methods are compared. FIG. 5 shows the chemical performance curve obtained by the system for optimization of dosing in water treatment according to the present invention and the curve obtained by the existing jar test. In FIG. 5, the abscissa represents the flocculant dosage, the left ordinate represents the flocculation index, and the right ordinate represents the supernatant turbidity. In FIG. 5, curve 501 represents the correlation between the flocculant dosage and the flocculation index obtained by the present invention. Curve 502 represents the correlation between the flocculant dosage and the supernatant turbidity obtained by the present invention. The results indicate that the optimal dosage obtained by the present invention at the maximal flocculation index (FI) is consistent with the optimal dosage determined according to the supernatant turbidity by manual suspended solids separation tests.

Furthermore, the present invention also relates to a water treatment system, which can treat water by adding chemical reagents into the water stream at the optimal dosages determined by the system for optimization of dosing in water treatment. In particular, the water treatment system includes a main water stream and a bypass pipe. The main water stream may be in the form of a pipe, or a river stream, or any suitable form for the water to flow. The bypass pipe takes a water sample from the main water stream section, and the water sample in the bypass pipe is treated by the system for optimization of dosing in water treatment according to the present invention, so as to determine an optimal dosage of the chemical reagent required for coagulating the particles in the water sample. A main dosing section of the water treatment system determines the dosage of the chemical reagent to be added into the main water stream section according to the dosage determined by the system for optimization of dosing in water treatment, and adds the chemical reagent into the main water stream to treat the same. Particularly, the main dosing section can determine the dosage of the chemical reagent required to be added in the main water stream by multiplying the dosage determined through the system for optimization of dosing in water treatment by a flow ratio between the main water stream and the bypass water sample.

The particular embodiments and the detailed description are not intended to limit the scope of protection of the present invention, and those skilled in the art can make corresponding improvements and modifications within the scope of the disclosure of the present invention, which are also within the scope of protection of the present invention.

1. A system for optimization of dosing in water treatment, which is used for optimizing the dosage of the chemical reagent for coagulating particles during the water treatment, said system comprising:
a chemical reagent addition device, for adding a certain dosage of a chemical reagent into a water sample to be treated at a predetermined interval,
an optical detection module, for detecting in real time a change in particle size of the particles in the water sample after the addition of the chemical reagent, and
a chemical reagent dosage determination device, which determines an optimized dosage of the chemical reagent for coagulating the particles in the water sample, according to the correlation between the change in particle size obtained by the optical detection module and the dosage of the added chemical reagent.

2. The system for optimization of dosing in water treatment as claimed in claim 1, wherein the optical detection module and the chemical reagent addition device are separated by a predetermined distance, and the optical detection module is arranged downstream of the flow of water sample with respect to the chemical reagent addition device.

3. The system for optimization of dosing in water treatment as claimed in claim 1, wherein said optical detection module comprises:
a light-emitting section, for emitting light to a water sample;
a light-receiving section, for receiving one or more of the reflected light, transmitted light, and scattered light from the water sample; and
an optical signal processing section, for converting the light from the light receiving section into an electrical signal, and determining the change in particle size of the particles in the water sample according to the electrical signal.

4. The system for optimization of dosing in water treatment as claimed in claim 1, wherein the chemical reagent addition device increases the dosage of the chemical reagent sucessively at the interval, and the increment of the chemical reagent is preset.

5. The system for optimization of dosing in water treatment as claimed in claim 1, further comprising a data transmitting device, which transmits and records the change value in particle size obtained by the optical detection module, and controls and records the dosages added each time by the chemical reagent addition device.

6. The system for optimization of dosing in water treatment as claimed in claim 1, wherein the chemical reagent addition section determines the current dosage of the chemical reagent to be added into the water sample according to the change value in particle size caused by previous addition of the chemical reagent into the water sample.

7. The system for optimization of dosing in water treatment as claimed in claim 6, the chemical reagent addition section determines the current dosage of the chemical reagent to be added into the water sample according to the change values in particle size caused by the previous two additions of the chemical reagent into the water sample.

8. The system for optimization of dosing in water treatment as claimed in claim 6, if a previously measured change value in particle size is smaller than a predetermined threshold, the chemical reagent addition device increases the amount of the reagent added; and if the previously measured change value in particle size is greater than the predetermined threshold, the chemical reagent addition device decreases the amount of the reagent currently added or keeps it unchanged.

9. The system for optimization of dosing in water treatment as claimed in claim 1, further comprising a water stream adjusting section, which adjusts the stability and residence time of the water stream.

10. The system for optimization of dosing in water treatment as claimed in claim 9, wherein the water stream adjusting section is a pipe system consisting of straight pipes and bent pipes.

11. The system for optimization of dosing in water treatment as claimed in claim 1, further comprising a mixer arranged upstream of the water stream with respect to the optical detection module, for fully mixing the water stream and the added chemical reagent.

12. The system for optimization of dosing in water treatment as claimed in claim 1, further comprising one or more of a tap water supply section, a compressed air supply section, and a supersonic transmitter, wherein the tap water supply section and the compressed air supply section is able to supply tap water and compressed air respectively to the pipes so as to clean the pipes, and the supersonic transmitter is able to transmit a supersonic wave to the optical probe of the optical detection module, so as to clean the optical probe.

13. The system for optimization of dosing in water treatment as claimed in claim 12, wherein the supersonic transmitter is arranged at a position near the optical probe of the optical detection module.

14. The system for optimization of dosing in water treatment as claimed in claim 1, further comprising a water quality parameter monitoring section, which monitors a water quality parameter of the water sample to determine whether the water sample is suitable for a particle coagulation process, wherein said water quality parameter includes one or more of the pH value, temperature, pressure and flow.

15. The system for optimization of dosing in water treatment as claimed in claim 14, further comprising an alerting section, which issues an alarm to a user if the water quality parameter monitoring section determines that the water sample is not suitable for a particle coagulation process.

16. The system for optimization of dosing in water treatment as claimed in claim 14, wherein, with respect to the chemical reagent addition section, the water quality parameter monitoring section is arranged upstream thereof.

17. The system for optimization of dosing in water treatment as claimed in claim 14, further comprising a pre-treatment section, which pre-treats the water sample to adjust a water quality parameter of the water sample, so that the water sample is suitable for a particle coagulation process, wherein said water quality parameter includes one or more of the pH value, temperature, pressure and flow.

18. A water treatment system, comprising:
a main water stream,
a bypass water stream extracted or branched from the main water stream;
a system for optimization of dosing in water treatment as claimed in claim 1, which is used for adding a certain dosage of a chemical reagent into the bypass water stream at a predetermined interval, so as to determine an optimized dosage of the chemical reagent added for coagulating particles in the bypass water stream, and
a main dosing device, which determines the dosage of the chemical reagent to be added into the main water stream according to the optimized dosage for the chemical reagent determined by the system for optimization of dosing in water treatment, and adds the chemical reagent into the main water stream.

19. The water treatment system as claimed in claim 18, wherein
said main dosing device determines the dosage of the chemical reagent to be added in the main water stream by multiplying the dosage in the bypass water stream determined through the system for optimization of dosing in water treatment by a flow ratio between the main water stream and the bypass water stream.

20. A method for optimization of dosing in water treatment, which is used for optimizing the dosage of a chemical reagent for coagulating particles, the method comprising the following steps:
(a) adding a certain dosage of a chemical reagent into a water sample to be treated at a predetermined interval,
(b) detecting in real time a change in particle size of the particles in the water sample after the chemical reagent is added by using an optical signal, and
(c) determining an optimized dosage of the chemical reagent for coagulating particles in the water sample, according to the correlation between the change in particle size detected by the optical signal and the dosage of the added chemical reagent.

21.-33. (canceled)
